(19) United States
(12) Patent Application Publication
(10) Pub. No.: US 2026/0246918 A1
(43) Pub. Date: Aug. 20, 2026

(54) METHOD AND APPARATUS FOR CONSTRUCTING CANDIDATE LIST FOR INHERITING NEIGHBORING CROSS-COMPONENT MODELS FOR CHROMA INTER CODING

(71) Applicant: MEDIATEK INC., Hsinchu City (TW)

(72) Inventors: Hsin-Yi TSENG, Hsinchu City (TW); Man-Shu CHIANG, Hsinchu City (TW); Chia-Ming TSAI, Hsinchu City (TW); Cheng-Yen CHUANG, Hsinchu City (TW); Chih-Wei HSU, Hsinchu City (TW); Yi-Wen CHEN, San Jose, CA (US)

(21) Appl. No.: 19/470,853

(22) PCT Filed: Jul. 5, 2024
(86) PCT No.: PCT/CN2024/104045

§ 371 Date: Sep. 30, 2025

Related U.S. Application Data
(60) Provisional application No. 63/511,922, filed on Jul. 5, 2023.

(51) Int. Cl. H04N 19/103; H04N 19/176; H04N 19/186

(52) U.S. Cl. CPC H04N 19/103; H04N 19/176; H04N 19/186

(57) ABSTRACT

Methods and apparatus for video decoding are disclosed. According to this method, input data associated with a current block of a current image of a video is received, and wherein the current block is coded in a non-intra mode. A candidate list corresponding to the block information is constructed, wherein the candidate list comprises cross-component models, and the cross-component models comprise at least one self-derived cross-component model or at least one temporal candidate generated according to at least one motion vector of the current block. A selected model from the candidate list is selected. The current block based on the selected model is reconstructed.

### FIELD OF THE INVENTION

The present invention relates to video coding system. In particular, the present invention relates to construct a candidate list for inheriting neighboring cross-component models for chroma inter coding.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously encoded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then encoded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, de-blocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H. 264, VVC or any other video coding standard.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

In order to improve the coding performance for a system using cross-component models, methods and apparatus of reconstructing based on the candidate list comprising cross-component models are disclosed.

### BRIEF SUMMARY OF THE INVENTION

A method for video decoding is disclosed. According to this method, input data associated with a current block of a current image of a video is received, and wherein the current block is coded in a non-intra mode. A candidate list corresponding to the current block is constructed, wherein the candidate list comprises cross-component models, and the cross-component models comprise at least one self-derived cross-component model or at least one candidate generated according to motion information of the current block. One or more selected models from the candidate list are selected. The current block is reconstructed based on the one or more selected models. In some embodiments, the motion information of the current block is a motion vector or a block vector of the current block.

In one embodiment, the video decoding method further comprises that chroma prediction of the current block is generated from luma information of the current block based on the one or more selected models to reconstruct the current block.

In one embodiment, the cross-component models further comprise inherited cross-component models. The inherited cross-component models comprise at least one of spatial model, temporal model, history-based model, pairwise average model or default model.

In one embodiment, the at least one self-derived cross-component model is CCRM.

In one embodiment, the self-derived cross-component model is derived through a weight derivation process, wherein the weight derivation process comprises calculating a relationship weight between a target chroma prediction and at least one of one or more source terms from luma component, one or more source terms from chroma components, and one or more bias terms.

In one embodiment, the method further comprises a candidate list modification process. The candidate list modification process comprises a reordering process, wherein the reordering process comprises a reordering rule for reordering the cross-component models in the candidate list. In one embodiment, the reordering rule is based on the model error calculated by computing the difference between the prediction generated by applying each of the cross-component models to the neighboring templates of the current block, and reconstruction of the neighboring template. In one embodiment, the difference is calculated using Sum of Absolute Difference (SAD). In another embodiment, the cross-component model with the smallest model error are selected to reconstruct the current block. The candidate list modification process comprises a pruning process. The pruning process comprises determining whether to include a new cross-component model into the candidate list by calculating a similarity between the new cross-component model and the cross-component models in the candidate list or by calculating a similarity between the new cross-component model and another self-derived models. The pruning process calculates the similarity based on the difference between the model parameters of two models. If the similarity is smaller than or equal to a threshold, the new cross-component model is not included in the candidate list.

According to another embodiment, a method for video encoding is disclosed. According to this method, input data associated with a current block of a current image of a video is received, and wherein the current block is coded in a non-intra mode. A candidate list corresponding to the current block is constructed, wherein the candidate list comprises cross-component models, and the cross-component models comprise at least one self-derived cross-component model or at least one temporal candidate generated according to at least one motion vector of the current block. One or more selected models from the candidate list are selected. The chroma information of the current block is encoded from luma information of the current block based on the one or more selected models.

According to another embodiment, an apparatus for video decoding is disclosed. The apparatus comprises a processer. A processer is configured to: receive input data associated with a current block of a current image of a video, and wherein the current block is coded in a non-intra mode; construct a candidate list corresponding to the current block, wherein the candidate list comprises cross-component models, and the cross-component models comprise at least one self-derived cross-component model or at least one temporal candidate generated according to at least one motion vector of the current block; select one or more selected models from the candidate list; and reconstruct chroma information of the current block from the luma information of the current block based on the one or more selected models.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 shows the intra prediction modes as adopted by the VVC video coding standard.

FIG. 3 illustrates an example of template-based intra mode derivation (TIMD) mode, where TIMID implicitly derives the intra prediction mode of a CU using a neighboring template at both the encoder and decoder.

FIG. 4 illustrates an example of spatial part of the convolutional filter for CCCM.

FIG. 5 illustrates an example of reference area (with its paddings) used to derive the CCCM filter coefficients.

FIG. 6 illustrates 16 gradient patterns for Gradient Linear Model (GLM).

FIG. 7 illustrates a proposed method on the decoder with cross-component residual model (CCRM) to predict chroma samples from reconstructed luma samples.

FIG. 8 illustrates the neighbouring blocks used for deriving spatial merge candidates for VVC.

FIG. 9 illustrates an example of temporal candidate derivation, where a scaled motion vector is derived according to POC (Picture Order Count) distances.

FIG. 10 illustrates the position for the temporal candidate selected between candidates C₀ and C₁.

FIG. 11 illustrates an example of the reference region of the current block, which is the spatial neighboring region of the current block.

FIG. 12 illustrates an example of inheriting temporal neighboring model parameters.

FIG. 13 illustrates an example of inheriting non-adjacent spatial neighboring models.

FIG. 14 illustrates an example of the neighboring templates for calculating model error.

FIG. 15 illustrates an example of inheriting candidates from the candidates in the candidate list of neighbors.

FIG. 16 illustrates a flowchart of a video decoding method according to an embodiment of the present invention.

FIG. 17 illustrates a flowchart of a video encoding method according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The VVC standard incorporates various new coding tools to further improve the coding efficiency over the HEVC standard. Among various new coding tools, some coding tools relevant to the present invention are reviewed as follows.

### Partitioning of the CTUs Using a Tree Structure

In VVC, the coding tree scheme supports the ability for the luma and chroma to have a separate block tree structure. For P and B slices, the luma and chroma CTBs in one CTU have to share the same coding tree structure. However, for I slices, the luma and chroma can have separate block tree structures. When the separate block tree mode is applied, luma CTB is partitioned into CUs by one coding tree structure, and the chroma CTBs are partitioned into chroma CUs by another coding tree structure. This means that a CU in an I slice may consist of a coding block of the luma component or coding blocks of two chroma components, and a CU in a P or B slice always consists of coding blocks of all three color components unless the video is monochrome.

### Virtual Pipeline Data Units (VPDUs)

Virtual pipeline data units (VPDUs) are defined as non-overlapping units in a picture. In hardware decoders, successive VPDUs are processed by multiple pipeline stages at the same time. The VPDU size is roughly proportional to the buffer size in most pipeline stages, so it is important to keep the VPDU size small. In most hardware decoders, the VPDU size can be set to maximum transform block (TB) size. However, in VVC, ternary tree (TT) and binary tree (BT) partition may lead to the increasing of VPDUs size.

Intra Mode Coding with 67 Intra Prediction Modes

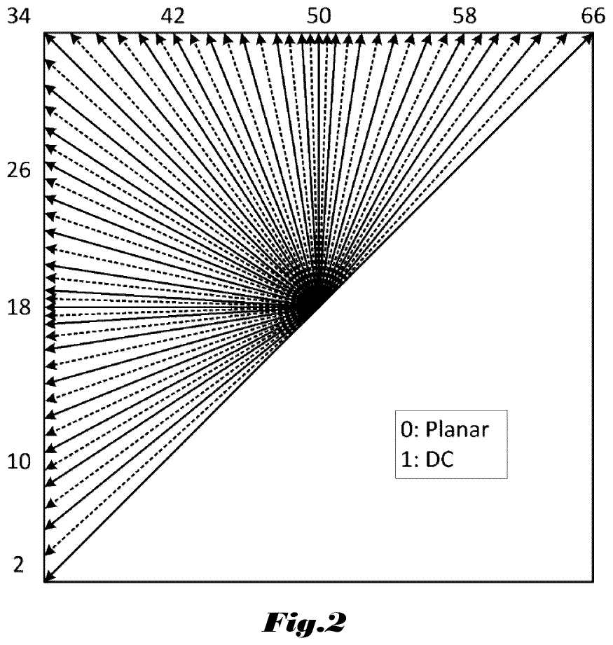

To capture the arbitrary edge directions presented in natural video, the number of directional intra modes in VVC is extended from 33, as used in HEVC, to 65. The new directional modes not in HEVC are depicted as dotted arrows in FIG. 2, and the planar and DC modes remain the same. These denser directional intra prediction modes apply for all block sizes and for both luma and chroma intra predictions.

To keep the complexity of the most probable mode (MPM) list generation low, an intra mode coding method with 6 MPMs is used by considering two available neighboring intra modes. The following three aspects are considered to construct the MPM list:
Default intra modes
Neighboring intra modes
Derived intra modes.

### Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i,j) represents the predicted chroma samples in a CU and rec_{L}(i,j) represents the downsampled reconstructed luma samples of the same CU.

The CCLM parameters (α and β) are derived with at most four neighboring chroma samples and their corresponding down-sampled luma samples. Suppose the current chroma block dimensions are W×H, then W″ and H′ are set as
W′=W, H′=H when LM_LA mode is applied.
W′=W+H when LM_A mode is applied.
H′=H+W when LM_L mode is applied.

The terms of {LM_LA, LM_L, LM_A} and {CCLM_LT, CCLM_L, CCLM_T} are used interchangeably in this disclosure. CCLM_A and CCLM_T are also used interchangeably.

### MMLM Overview (Multiple Model CCLM)

As indicated by the name, the original CCLM mode employs one linear model for predicting the chroma samples from the luma samples for the whole CU, while in MMLM (Multiple Model CCLM), there can be two models. In MMLM, neighboring luma samples and neighboring chroma samples of the current block are classified into two groups, each group is used as a training set to derive a linear model (i.e., a particular a and R are derived for a particular group). Furthermore, the samples of the current luma block are also classified based on the same rule for the classification of neighboring luma samples.

Threshold is calculated as the average value of the neighboring reconstructed luma samples. A neighboring sample with Rec′_{L}[x,y]<=Threshold is classified into group 1; while a neighboring sample with Rec′_{L}[x,y]>Threshold is classified into group 2.

Correspondingly, a prediction for chroma is obtained using linear models:

### Local Illumination Compensation (LIC)

Local Illumination Compensation (LIC) is a method to do inter predict by using neighbor samples of current block and reference block. It is based on a linear model using a scaling factor a and an offset b. It derives the scaling factor a and an offset b by referring to the neighbor samples of current block and reference block. Moreover, it's enabled or disabled adaptively for each CU.

For more detail for LIC, it can refer to the document “JVET-C1001, title: Algorithm Description of Joint Exploration Test Model 3”.

### Decoder Side Intra Mode Derivation (DIMD)

To implicitly derive the intra prediction modes of a block, a texture gradient analysis is performed at both the encoder and decoder sides. This process starts with an empty Histogram of Gradient (HoG) with 65 entries, corresponding to the 65 angular modes. Amplitudes of these entries are determined during the texture gradient analysis.

### Template-Based Intra Mode Derivation (TIMD)

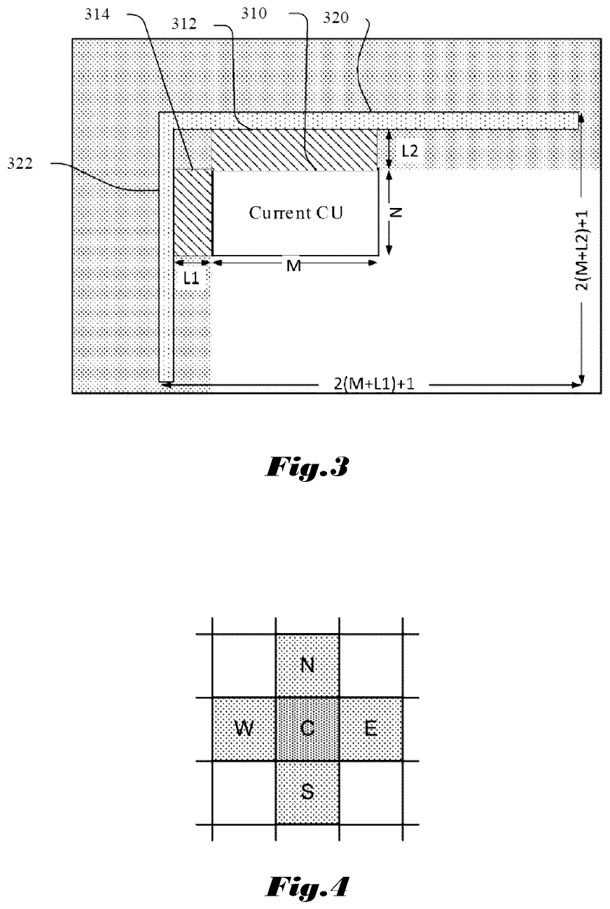

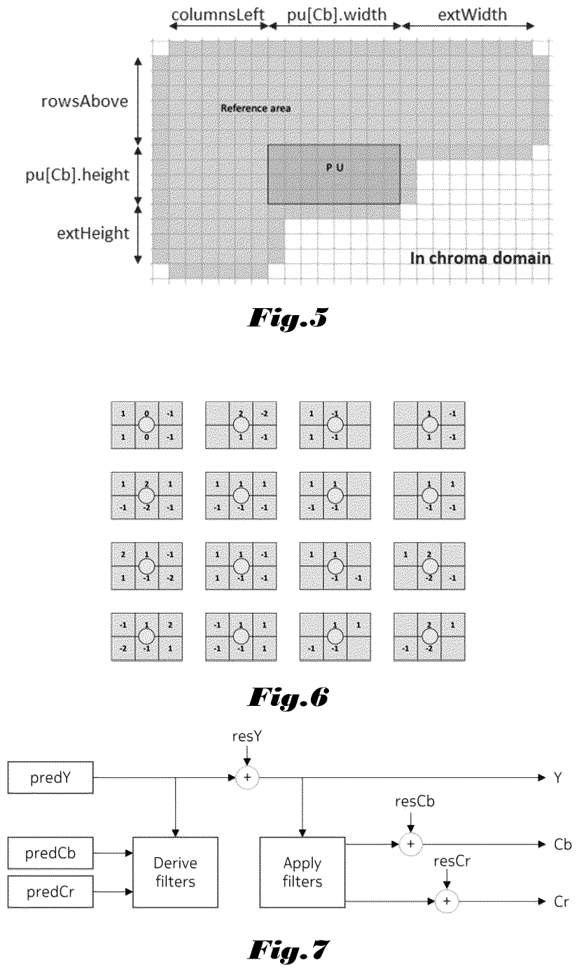

Template-based intra mode derivation (TIMID) mode implicitly derives the intra prediction mode of a CU using a neighboring template at both the encoder and decoder, instead of signalling the intra prediction mode to the decoder. As shown in FIG. 3, the prediction samples of the template (312 and 314) for the current block 310 are generated using the reference samples (320 and 322) of the template for each candidate mode. A cost is calculated as the SATD (Sum of Absolute Transformed Differences) between the prediction samples and the reconstruction samples of the template. The intra prediction mode with the minimum cost is selected as the TIMD mode and used for intra prediction of the CU. The candidate modes may be 67 intra prediction modes as in VVC or extended to 131 intra prediction modes. In general, MPMs can provide a clue to indicate the directional information of a CU. Thus, to reduce the intra mode search space and utilize the characteristics of a CU, the intra prediction mode can be implicitly derived from the MPM list.

### Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side.

### Convolutional Cross-Component Model (CCCM)

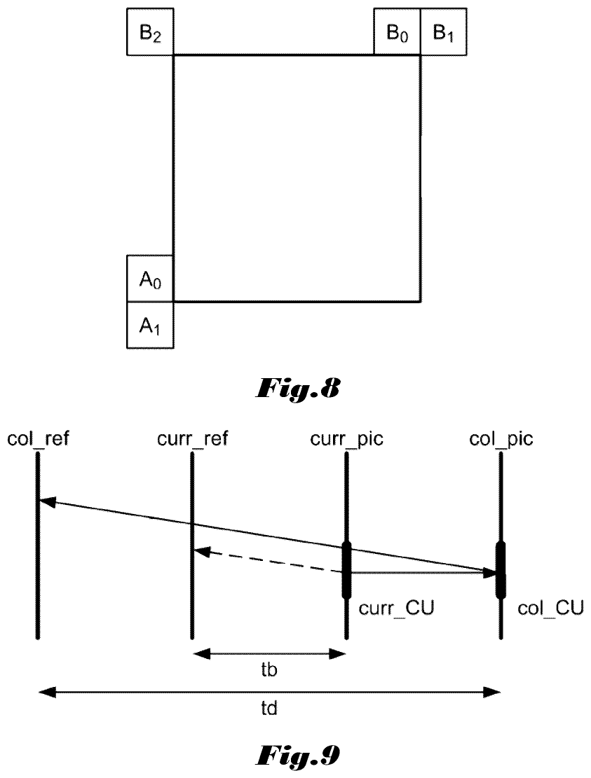

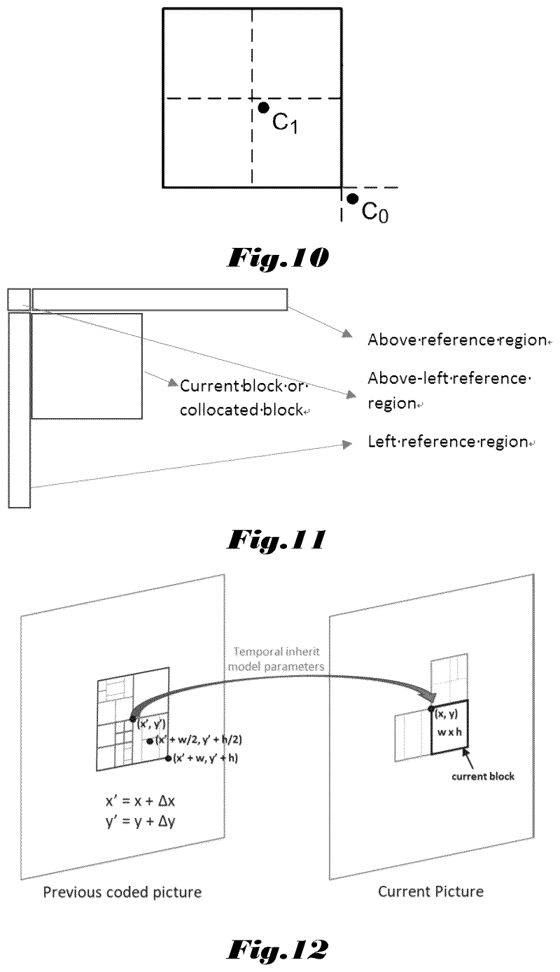

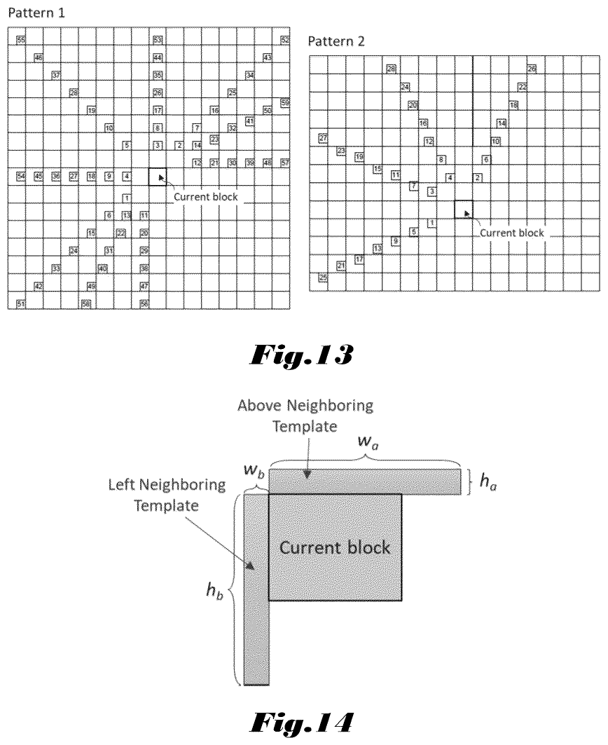

In CCCM, a convolutional model is applied to improve the chroma prediction performance. The convolutional model uses a 7-tap filter consisting of a 5-tap plus sign shape spatial component, a nonlinear term and a bias term. The input to the spatial 5-tap component of the filter consists of a centre (C) luma sample which is collocated with the chroma sample to be predicted and its above/north (N), below/south (S), left/west (W) and right/east (E) neighbors as shown in FIG. 4.

The nonlinear term (denoted as P) is represented as power of two of the centre luma sample C and scaled to the sample value range of the content:

$$P = ( C * C + midVal ) >> bitDepth \qquad ( 4 )$$

Accordingly, for 10-bit contents, it is calculated as:

$$P = ( C * C + 5 \; 12 ) >> 10 \qquad ( 5 )$$

The bias term (denoted as B) represents a scalar offset between the input and output (similarly to the offset term in CCLM) and is set to the middle chroma value (e.g., 512 for 10-bit contents).

Output of the filter at a current pixel location (i.e., “C” in FIG. 4) is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B \qquad ( 6 )$$

The filter coefficients ci are calculated by minimizing MSE between predicted and reconstructed chroma samples in the reference area. FIG. 5 illustrates the reference area which consists of 6 lines of chroma samples above and left of the PU. Reference area extends one PU width to the right and one PU height below the PU boundaries. Area is adjusted to include only available samples.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM, however LDL decomposition was chosen instead of Cholesky decomposition to avoid using square root operations.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

FIG. 6 illustrates 16 gradient patterns for Gradient Linear Model (GLM). For signaling, when the CCLM mode is enabled to the current CU, two flags are signaled separately for Cb and Cr components to indicate whether GLM is enabled to each component; if the GLM is enabled for one component, one syntax element is further signaled to select one of 16 gradient filters for the gradient calculation. The GLM can be combined with the existing CCLM by signaling one extra flag in bitstream. When such combination is applied, the filter coefficients that are used to derive the input luma samples of the linear model are calculated as the combination of the selected gradient filter of the GLM and the down-sampling filter of the CCLM.

### Intra Block Copy

Intra block copy (IBC) is a tool adopted in HEVC extensions on SCC (Screen Content Coding). It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector is rounded to integer precision as well. When combined with AMVR (Adaptive Motion Vector Resolution), the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

### Cross-Component Residual Model (CCRM)

As in JVET-AD0108, it is to apply cross-component residual model (CCRM) to predict chroma samples from reconstructed luma samples when the block uses inter prediction or intra block copy (IBC). FIG. 7 illustrates a proposed method on the decoder with cross-component residual model (CCRM) to predict chroma samples from reconstructed luma samples. The cross-component filters are derived using the prediction signals of luma and chroma. The derived filters are applied to the reconstructed luma signal producing the final chroma predictions.

### Chroma DM (Derived Mode) Mode

For Chroma DM mode, the intra prediction mode of the corresponding (collocated) luma block covering the centre position of the current chroma block is directly inherited.

### Inter Prediction Overview (More Details can be Found in JVET-T2002 Section 3.4.)

According to JVET-T2002 Section 3.4. (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)), for each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded (i.e., encoded or decoder) with skip mode, the CU is associated with one PU and has no significant residual coefficients, no coded motion vector delta or reference picture index. A merge mode is specified whereby the motion parameters for the current CU, which are obtained from neighboring CUs, including spatial and temporal candidates, and additional schedules introduced in VVC. The merge mode can be applied to any inter-predicted CU, not only for skip mode. The alternative to the merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

### Spatial Candidates Derivation

The derivation of spatial merge candidates in VVC is the same as that in HEVC except that the positions of first two merge candidates are swapped. A maximum of four merge candidates (B0, A0, B1 and A1) for current CU are selected among candidates located in the positions depicted in FIG. 8. The order of derivation is B0, A0, B1, A1 and B2. Position B2 is considered only when one or more neighbouring CU of positions B0, A0, B1, A1 are not available (e.g. belonging to another slice or tile) or is intra coded. After candidate at position A0 is added, the addition of the remaining candidates is subject to a redundancy check which ensures that candidates with the same motion information are excluded from the list so that coding efficiency is improved.

### Temporal Candidates Derivation

In this step, only one candidate is added to the list. Particularly, in the derivation of this temporal merge candidate for a current CU, a scaled motion vector is derived based on the co-located CU belonging to the collocated reference picture as shown in FIG. 9. The reference picture list and the reference index to be used for the derivation of the co-located CU is explicitly signalled in the slice header. The scaled motion vector for the temporal merge candidate is obtained as illustrated by the dotted line in FIG. 9, which is scaled from the motion vector of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

The position for the temporal candidate is selected between candidates C0 and C1, as depicted in FIG. 10. If CU at position C0 is not available, is intra coded, or is outside of the current row of CTUs, position C1 is used. Otherwise, position C0 is used in the derivation of the temporal merge candidate.

### History-Based Merge Candidates Derivation

The history-based MVP (HMVP) merge candidates are added to the merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

### Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate id defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; and if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

### Merge Estimation Region

Merge estimation region (MER) allows independent derivation of merge candidate list for the CUs in the same merge estimation region (MER). A candidate block that is within the same MER as the current CU is not included for the generation of the merge candidate list of the current CU. In addition, the updating process for the history-based motion vector predictor candidate list is updated only if (xCb+cbWidth)>>Log 2ParMrgLevel is greater than xCb>>Log 2ParMrgLevel and (yCb+cbHeight)>>Log 2ParMrgLevel is great than (yCb>>Log 2ParMrgLevel), and where (xCb, yCb) is the top-left luma sample position of the current CU in the picture and (cbWidth, cbHeight) is the CU size. The MER size is selected at the encoder side and signalled as log2_parallel_merge_level_minus2 in the Sequence Parameter Set (SPS).

### Constructing Candidate List for Inheriting Neighboring Cross-Component Models for Chroma Inter Coding

The cross-component information is used to improve prediction accuracy of an inter block. A video consists of multiple images, including a current image. A current image consists of multiple blocks, including a current block. A current block of the current image of the video includes input data associated with a current block. It should be noted that the current block is coded (i.e., encoded or decoded) in a non-intra mode.

To improve the prediction accuracy of the chroma component of the inter block, the luma information from the corresponding luma component and/or the chroma information from the previous coded chroma component are used.
The first scheme is that for a coding unit (under single tree splitting) including luma (Y) and chroma (Cb and/or Cr) components, the prediction for Cb and/or Cr is improved by using the information from Y.
The second scheme is that for a coding unit (under single tree splitting) including luma (Y) and chroma (Cb and/or Cr) components or for a coding unit (under chroma dual tree splitting) including chroma (Cb and/or Cr) components, the prediction for Cr is improved by using the information from Cb. For example, model parameters can be derived by using neighboring reconstructed samples of Cb and Cr as the inputs X and Y of model derivation. Then Cr prediction can be generated by the derived model parameters and Cb reconstructed samples.

In the following, several embodiments related to the first scheme are proposed to use an inherited cross-component mode for the current chroma block of the current image of the video by (a) building a candidate list for the current block where the candidate list includes cross-component models (b) selecting one or more model information in the list and (c) using the model information (similar to intra chroma cross-component mode) to generate one or more hypotheses of predictions for the current chroma component (Cb or Cr) by applying and/or modifying the selected model information to the reconstructed or predicted samples for the corresponding luma component. When the selected model information refers to traditional cross-component linear model(s), the proposed method is called as inter cross-component linear model (inter CCLM) mode. When the selected model information refers to convolutional cross-component model(s) derived by a regression-based method (as CCCM for example), the proposed method is called as inter cross-component convolution model (inter CCCM) mode. Moreover, in some embodiments, a self-derived (re-derived) cross-component mode is proposed and can be added into the candidate list in step (a) “building a candidate list for the current block where the candidate list includes cross-component models”. In some embodiments, the selection of using the proposed inherited mode and/or using the proposed self-derived mode is determined following an explicit rule, an implicit rule, or both. More details are described in the section entitled “(4) Selection of using the proposed inherited mode and/or using the proposed self-derived mode”.

In one embodiment, the proposed embodiments can also be used for the second scheme by using the previous coded chroma component (Cb) as the luma component in the first scheme.

### Storage of the Model for the Current Block

In another embodiment, when the current inter block uses the model parameters from the self-derived cross-component mode, the used model parameters can be saved and/or reference by the following coding blocks.

In another embodiment, when the current inter block uses the inherited cross-component mode, the used model parameters can be saved and/or reference by the following coding blocks.

### (1) Building a Candidate List Including Cross-Component Models

In one embodiment, when building the merge-like candidate model list (modelList), one or more of the following candidate model information are included.
Spatial model information from spatial neighbor blocks (corresponding to “Spatial MVP from spatial neighbor CUs” for inter)
Temporal model information from collocated blocks (corresponding to “Temporal MVP from collocated CUs” for inter)
History-based model information from a FIFO table (corresponding to “History-based MVP from a FIFO table” for inter)
Pairwise average model information (corresponding to “Pairwise average MVP” for inter)
Default model information (corresponding to “Zero MVs” for inter)

In one sub-embodiment of the candidate type being “Spatial model information from spatial neighbor blocks”, a valid spatial neighboring block(s) of the current block can be from one of spatial adjacent and non-adjacent neighbors (or any subset of the blocks in a neighboring search region for the current block) which satisfies a pre-defined condition. For example, the pre-defined condition is that the neighbor is coded by a cross-component mode (such as CCLM, MMLM, CCCM, GLM, the mode with mode information inherited from a merge-like candidate list, MH CCLM, and/or any cross-component mode with syntax not belonging to tradition intra prediction modes) or by a mode combining with cross-component modes (such as chroma fusion (or named LM assisted Angular/Planar Mode), inter CCLM, inter CCCM, and/or any traditional mode with syntax not belonging to cross-component modes but using the cross-component information to generate the prediction). When scanning the spatial neighboring blocks, a candidate is added into the list if the candidate is valid.

In another sub-embodiment of the candidate type being “Temporal model information from collocated blocks”, the collocated block is from the block in the reference picture as inter mode. For example, when the current block is coded by inter prediction mode, the collocated block is referred by the motion information (including the motion vectors and the reference picture) of the current block. If the current block is a subblock motion mode (e.g. affine mode), each subblock in the current block has its own collocated temporal model information and/or all or any subset of collocated temporal model information referred by the different subblock motions are added into the list. For another example, the temporal model information can be from the collocated block referred by the motion information of the neighboring blocks for the current block. If the proposed methods are applied to an IBC block or any mode using block vectors, block vector information is used as motion vector where the block vector information is determined by signalling and/or template matching in a pre-defined searching range and/or any implicit or explicit pre-defined rules. On the basis of the above, cross-component models may comprise at least one temporal candidate generated according to the motion vector of the current block.

In another sub-embodiment of the candidate type being “History-based model information”, a history-based table (the FIFO table) is built and stores the model information from the previous coded blocks. The table can be reset at the beginning and/or end of a CTU, slice, picture, tile, and/or sequence. One or more history-based candidates can be added into the candidate list by the order from the head to tail of the table or from the tail to head of the table.

In another sub-embodiment of the candidate type being “Pairwise average model information”, the model information of this candidate is derived based on the model information from more than one of the previous candidates in the list. For example, it can average and/or modify the model parameters of more than one candidate as the to-be-applied model parameters. For another example, it can combine more than one prediction as the final prediction, where each of the more than one prediction is generated by applying one of models in the candidate list.

In another sub-embodiment, the default model information is added if the list is not full after inserting all pre-defined candidates. Some examples of the default CCLM model information are shown below.

For example, the default alpha (or named as α, a, or scaling parameters) are {0, ⅛, −⅛, 2/8, − 2/8, ⅜, −⅜, . . . }, and the beta (or named as β, b, or offset parameter) is based on the selected default alpha, average neighboring reconstructed luma sample value, and average neighboring reconstructed chroma (Cb/Cr) sample value.

In another embodiment, when building modelList, one or more self-derived cross-component candidates are included. In one sub-embodiment, an example of the self-derived cross-component candidate is CCRM. The cross-component prediction (containing target predicted samples) of the current bock is formed by combining one or more proposed source terms and the models (referring to a proposed weighting setting). As shown in Equation (7), pred(i, j) is a target (predicted) sample in the current block which can be obtained after our proposed mechanism, sourceTermSet0 includes one or more source terms from luma component, sourceTermSet1 includes one or more source terms from chroma components, and biasTermSet includes one or more bias terms.

Equation (7) is just an example and our proposed mechanism can use any subset or extension of sourceTermSet0, sourceTermSet1, and biasTermSet. Each sample or any subset of samples in the current block gets its target (predicted) sample according to Equation (7).

$$pred ( i , j ) = ( sourceTermSet 0 ( i , j ) + sourceTermSet 1 ( i , j ) + … + biasTermSet ) with the proposed weighting setting where ( i , j ) is a sample position in the current block . \qquad ( 7 )$$

The content of sourceTermSet0 is described in Section 1.1 “Content of sourceTermSet0(i, j)”, the content of sourceTermSet1 is described in Section 1.2 “Content of sourceTermSet1(i, j)”, the content of biasTermSet is described in Section 1.3 “Content of biasTermSet”, and the predictor derivation using the proposed source terms and the proposed weighting setting is described in Section 1.4 “Predictor derivation for sample (i, j)”. Several examples with our proposed mechanism are shown in Section 1.4.

1.1. Content of sourceTermSet0(i, j)

SourceTermSet0(i, j) includes one or more luma source terms denoted as sourceTerm00, sourceTerm01, . . . , and/or sourceTerm0n−1. The value of n means the number of taps for the source term set. In one embodiment, the source terms can be linear terms, and/or non-linear terms, only linear terms, and/or only non-linear terms. In another embodiment, the pattern of the n taps refers to a pattern defined as any subset of a window region M×N around/including the position (iL, jL). If the target sample is chroma (e.g., Cb or Cr), (iL, jL) is the collocated luma position from (i, j).

For a source term in the source term set, the following embodiments are used to determine generation of source content.

In one embodiment, the source content is based on a predicted sample generated by a prediction mode and/or a reconstructed sample generated based on the predicted sample by a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples.

In another sub-embodiment, since the target sample belongs to a chroma sample (e.g., Cb or Cr)), the predicted sample and/or the reconstructed sample is located within the collocated (luma) block from the current (chroma) block. The predicted sample and/or the reconstructed sample is treated as an initial sample and used as source content to generate the target sample.

In another embodiment, the values of the source terms are further adjusted (e.g., added or subtracted) by a pre-defined offset.

In another embodiment, the source term may further include location information.

1.2. Content of sourceTermSet1(i, j)

SourceTermSet1(i, j) includes one or more chroma (Cb or Cr) source terms denoted as sourceTerm00, sourceTerm01, . . . , and/or sourceTerm0m−1. The value of m means the number of taps for the source term set. In one embodiment, the source terms can be linear terms and/or non-linear terms, only linear terms, and/or only non-linear terms. In another embodiment, the pattern of the m taps refers to a pattern defined as any subset of a window region M2×N2 around/including the position (iC, jC). If the target sample is chroma (Cb or Cr), (iC, jC) is (i, j).

For a source term in the source term set, the following embodiments are used to determine generation of source content.

In one embodiment, the source content is based on a predicted sample generated by a prediction mode and/or a reconstructed sample generated based on the predicted sample by a prediction mode and a reconstructed residual.

In another sub-embodiment, the source content is the filtered source or the source with any pre-processing. For example, the source content is the predicted/reconstructed sample after filtering with a pre-defined model or filter.

In another sub-embodiment, the source content is gradient information from the predicted samples and/or reconstructed samples.

In another sub-embodiment, if the target sample belongs to a chroma sample, the predicted sample and/or the reconstructed sample is located within the current block. The predicted sample and/or the reconstructed sample is treated as an initial sample and used as source content to generate the target sample.

In another embodiment, the values of the source terms are further adjusted (e.g., added or subtracted) by a pre-defined offset.

In another embodiment, the source term may further include location information. For example, if the target sample refers to chroma, the horizontal location (i) of (i, j) is used in a source term and the vertical location (j) of (i, j) is used in a source term.

1.3. Content of biasTermSet

Bias term is a pre-defined value. In one embodiment, the bias term is a midValue according to bitDepth specified in the standard. For example, the bias term is set as (1<<(bitDepth−1)). In another embodiment, the bias term is the same for each sample in the current block. That is, the bias term is regardless of the position (i, j).

### 1.4. Predictor Derivation for Sample (i, j)

### 1.4.1. Proposed Weighting Setting

The proposed weighting setting is to estimate the relationship (minimize the distortion) between “the predicted and/or reconstructed samples on the reference region of the current (chroma) block” and “the predicted and/or reconstructed samples on the reference region of the corresponding luma block” by a pre-defined regression method, and to generate a weighting (referring to model parameters) according to the regression method. The weighting of the source terms derived is then applied to get the target (predicted) samples in the current block. In one embodiment, the pre-defined regression method can be linear minimum mean square error (LMMSE) method for CCLM or can be any unified method with the regression method used for CCLM. In another embodiment, the pre-defined regression method can be the LDL decomposition method for CCCM or can be any unified method with the regression method used for CCCM. In another embodiment, the pre-defined regression method can be Gaussian elimination.

In one embodiment, the reference region of the current block is the spatial neighboring region of the current block. The spatial neighboring region of the current block includes above reference region, left reference region, above-left reference region, and/or any subset of the above.

The reference region of the corresponding luma block is the spatial neighboring region of the corresponding luma block. FIG. 11 illustrates an example of the reference region of the current block, which is the spatial neighboring region of the current block.

In another embodiment, the reference region of the current block is the vector-collocated region of the current block and the reference region of the corresponding luma block is the vector-collocated region of the corresponding luma block. For inter coding unit containing luma and chroma blocks, the vector-collocated region of the current block refers to the motion compensated results obtained by using the motion information (motion vectors and reference pictures) of the current block, and the vector-collocated region of the corresponding luma block refers to the motion compensated results obtained by using the motion information (motion vectors and reference pictures) of the corresponding luma block. For IBC or intraTMP, the vector-collocated region of the current block refers to the motion compensated results obtained by using the motion information (block vectors and current picture) of the current block, and the vector-collocated region of the corresponding luma block refers to the motion compensated results obtained by using the motion information (block vectors and current picture) of the corresponding luma block.

In another embodiment, the above-proposed two kinds of the reference region of the current block can be used together. For example, generally, samples in the vector-collocated region of the current block are used as input samples when deriving model parameters; however, for a smaller block, samples in the spatial neighboring reference region are used as additional input samples when deriving model parameters.

In another embodiment, more details of construction of the modelList can be found in Section (6) “Constructing a candidate list”.

### (2) Signalling for Model Information Control

This section describes signalling of enabling or disabling the merge scheme, and also signaling to select one or more model information in the list if the merge scheme is enabled.

When not applying the proposed inter CCLM (or inter CCCM), the prediction of current block is from the original inter prediction.

In another embodiment, whether to apply inter CCLM (or inter CCCM) or not to apply inter CCLM (or inter CCCM) depends on signaling.

In one sub-embodiment, the signalling refers to a coded TU/TB/CU/CB level flag. In another embodiment, inter CCLM (or inter CCCM) can be supported only when the size conditions of the current block are satisfied.

In one sub-embodiment, the size condition is that the block width, block height, or block area is larger than a pre-defined threshold. The predefine threshold can a positive integer such as 8, 16, 32, 64, 128, 256, . . . .

In another sub-embodiment, the size condition is that the block width, block height, or block area is smaller than a pre-defined threshold. The predefine threshold can a positive integer such as 8, 16, 32, 64, 128, 256, 512, 1024, 2048, 4096, . . . .

In another embodiment, original inter prediction (generated by motion compensation) is used for luma and the predictions of chroma components are generated by CCLM and/or any other LM modes.

In one sub-embodiment, the current CU is viewed as an inter CU, intra CU, or a new type of prediction mode (neither intra nor inter).

In another embodiment, the one or more LM mode(s) (or cross-component mode(s)) which will be used to generate the one or more hypotheses of predictions for LM assisted Angular/Planar Mode/inter CCLM/inter CCCM/MHI CCLM are selected from a pre-defined merging candidate list (called modelList). One modelIdx is signalled to select a candidate from the candidate list (modelList) and the selected candidate is used for the current block. The modelList contains one or more candidates where each candidate refers to a model (or cross-component mode) information. If only one candidate is in the list (the size of the list is only 1), the modelIdx is not signalled, and/or can be inferred as 0 or a default value.

In one embodiment, when building modelList, one or more predefined candidates are added.

The pre-defined candidates can include any subset/extension of the following candidates:
CCLM family: CCLM_LT, CCLM_L, CCLM_T
MMLM family: MMLM_LT, MMLM_L, MMLM_T
CCCM family: CCCM_LT, CCCM_L, CCCM_T

The above proposed methods can be also applied to IBC blocks or the blocks with any IBC sub-modes (e.g., IBC merge or IBC AMVP or any IBC mode under IBC syntax). (“inter” in this invention can be changed to IBC.) That is, for chroma components, the block vector prediction can be combined or replaced with cross-component prediction.

### (3) Generate Hypotheses of Predictions

This section describes how to use the model information to generate one or more hypotheses of predictions for the current chroma component.

### 3.1. Concept

In one embodiment, prediction or reconstruction-based model is used to generate one hypothesis of prediction for the current chroma component.

In one sub-embodiment of a prediction based linear model, the derived model parameters are applied to the predicted samples for the first component (Y) to get the predicted samples for the second or third component.

$$P ( i , j ) = a \cdot {pred}_{L}^{′} ( i , j ) + b$$

The predicted samples for the first component are down-sampled with the downsampling filters (which may be fixed at one-predefined filter or selected among some candidate filters).

In another sub-embodiment of a reconstruction based linear model, the derived model parameters are applied to the reconstructed samples for the first component (Y) to get the predicted samples for the second or third component.

$$P ( i , j ) = a \cdot {reco}_{L}^{′} ( i , j ) + b$$

The reconstructed samples for the first component are down-sampled with the downsampling filters (which may be fixed at one-predefined filter or selected among some candidate filters).

Prediction or reconstruction based convolution model is similar to the proposed methods for the prediction or reconstruction based linear model. The main difference is that the model coefficient pattern follows CCCM (not CCLM) and the luma samples may or may not be down-sampled first. If not applying down-sampling to the luma samples, more taps (model coefficients) may be used to access the non-down-sampled luma samples.

### 3.2. CCLM for Inter Block

CCLM for inter block can also be named as inter CCLM and “CCLM” can be extended to any LM mode (or any cross-component mode) or replaced with any LM mode (or any cross-component mode). When convolutional cross-component models derived by a regression-based method is used, CCLM for inter block can also be named as inter CCCM.

In one embodiment, for chroma components, in addition to original inter prediction (generated by motion compensation which can be uni-prediction and/or bi-prediction, multiple hypotheses of prediction from multiple motion candidates which may refer to one or more merge candidates and/or one or more AMVP candidates, and/or any combination of above, or which can be only uni-prediction), one or more hypotheses of predictions (generated by CCLM and/or any other LM modes) are used to output the current prediction.

In one sub-embodiment, the current prediction is the weighted sum of inter prediction and CCLM prediction.

In another embodiment, the inter prediction can be generated by any inter mode mentioned in the above introduction/documents. For example, the inter mode can be regular merge mode. For another example, the inter mode can be CIIP mode. For another example, the inter mode can be GPM or any GPM variations (e.g., GPM intra referring one prediction unit using intra prediction).

In another embodiment, inter CCLM is supported only when any one (or more than one) of the pre-defined inter mode is used for the current block, or inter CCLM is supported when any one (or more than one) of the enabling flag(s) of the pre-defined inter mode is(are) indicated as enabled. The meaning of supporting inter CCLM is that the prediction of the current block can be chosen between applying inter CCLM or not applying inter CCLM.

For another example, if CCLM mode is used for generating the chroma prediction samples and luma prediction is from an inter coding tool, a flag is used to indicate if the CCLM model used for the chroma prediction is inherited from the CCLM models used in the previous coded blocks or the CCLM model is from a predetermined CCLM mode. If the CCLM model is inherited from the CCLM models used in the previous coded blocks, an index is used to indicate which model in the list is inherited or modified. Otherwise, a predetermined CCLM mode is used to implicitly derive the CCLM model for the current chroma prediction.

(4) Selection of Using the Proposed Inherited Mode and/or Using the Proposed Self-Derived Mode

In one embodiment, a flag can be signalled to indicate/select if the re-derived model is used. If the flag is 0, the cross-component model used to encode the neighbor merge candidate is inherited. If the flag is 1, the re-derived method is used.

In another embodiment, an implicit rule (not using the additional flag) is used to determine whether to use the re-derived model.

In another embodiment, when the proposed inherited method is used, the candidate with the smallest cost (e.g., the first candidate in the modelList) is implicitly selected to generate the cross-component prediction. For another example, an index is signalled to select one or more candidates from the modelList. More details can be found in Section (2) “Signalling for Model Information Control”.

### (5) Details of Cross-Component Model Information in Candidate List

### 5.1. Inheriting CCM Information

In one embodiment, the cross-component model (CCM) information of inherited cross-component model can be stored together with the inherited model parameters. The CCM information can be inherited together with the inherited model parameters. The prediction of the current block can be generated based on the inherited CCM information and inherited model parameters. The CCM information can include but not limited to prediction mode (e.g., CCLM, MMLM, CCCM, 2-parameter GLM, 3-parameter GLM), model index for indicating which model shape is used in convolutional model, classification threshold for multi-model, information to indicate non-downsampled samples are used in convolutional model, down-sampling filter flag, down-sampling filtering index when multiple down-sampling filters are used, number of neighboring lines used to derive model, types of templates used to derive model, post-filtering flag and model parameters.

In one embodiment, a mixed CCCM model consisting of various terms (e.g., spatial term, gradient term, location term, non-linear term and bias term) can be inherited. In addition to storing model parameters, a prediction mode can be stored in the CCM information to indicate that the inherited model is a mixed CCCM model consisting of various terms. If there are multiple types of mixed CCCM models, a model index can also be stored in the CCM information to indicate which type of mixed CCCM model is inherited. For example, gradient and location based CCCM (GL-CCCM) proposed in JVET-AB0119 is a mixed CCCM model which consists of one spatial term in center position, two gradient terms for horizontal direction and vertical direction, two location term X and Y for the relative horizontal location and relative vertical location, one non-linear term and one bias term. A prediction mode can be stored in the CCM information to indicate that the inherited model is a GL-CCCM model.

### 5.2. Inheriting Spatial Neighboring Model Parameters

In one embodiment, the inherited model parameters can be from a block that is an immediate neighboring block of the current block. The models from blocks at pre-defined positions are added into the candidate list in a pre-defined order.

In one embodiment, the pre-defined positions and the pre-defined order can be the same as those of spatial candidates for inter merge mode.

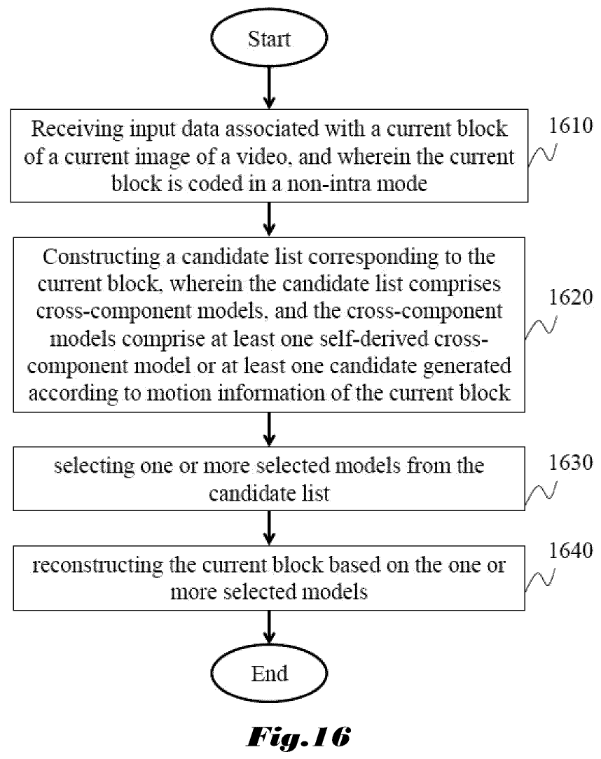

In one embodiment, the pre-defined positions can be the positions depicted in FIG. 16. The pre-defined order can be B₀, A₀, B₁, A₁ and B₂.

In one embodiment, assume the position, width and height of the current block are (x, y), W and H respectively, the pre-defined positions can include positions immediate above the current block, such as (x+W>>1, y−1) or (x+(W+1)>>1, y−1), if W is greater than or equal to a threshold TH. The pre-defined positions can also include positions immediate left to the current block, such as (x−1, y+H>>1) or (x−1, y+(H+1)>>1), if H is greater than or equal to a threshold TH. TH can be 2, 4, 8, 16, 32, or 64.

In one embodiment, there is a maximum number of inherited models from spatial neighbors that can be added into the candidate list, and the maximum number is smaller than the number of pre-defined positions.

### 5.3. Inheriting Temporal Neighboring Model Parameters

In one embodiment, if the current slice/picture is a non-intra slice/picture, the inherited model parameters can be from the block in the previous coded slices/pictures.

In one embodiment, the current block position is at (x, y) and the block size is w×h. The inherited model parameters can be from the block at some pre-defined positions of the previous coded slices/picture.

In one sub-embodiment, the pre-defined positions can be (x+Δx, y+Δy) or (x_{mid}+Δx,y_{mid}+Δy), where

$$( {x}_{m i d} , {y}_{mid} ) = ( x + \frac{w}{2} , y + \frac{h}{2} ) .$$

The two value sets αₓ and α_{y} are defined as:

$${α}_{x} = \{ {α}_{x 1} , {α}_{x 2} , {α}_{x 3} , … , {α}_{x n} \} , {α}_{x i} < {α}_{x j} if i < j$$

$${α}_{y} = \{ {α}_{y 1} , {α}_{y 2} , {α}_{y 3} , … , {α}_{y n} \} , {α}_{y i} < {α}_{y j} if i < j$$

All values in αₓ and α_{y} are positive numbers.

For example, (Δx, Δy) can be (±αₓᵢ×w, ±α_{yi}×h), (±αₓᵢ×w, 0), (0, ±α_{yi}×h), where δx and δy are two fixed positive numbers.

For example, αₓ=α_{y}. For example, αₓ=α_{y}={1, 2, 3, 4, 5}.

For example, αₓ≠α_{y}. For example,

$${α}_{x} = \{ \frac{1}{2} , 1 , \frac{3}{2} , 2 , \frac{5}{2} \}$$

and α_{y}={1, 2, 3, 4, 5}.

In one sub-embodiment, the pre-defined positions (x′, y′) are inside the corresponding area of the current encoding block, i.e., x≤x′<x+w and y≤y′<y+h. The pre-defined positions can be

$$( x , y ) , ( x + w - 1 , y ) , ( x , y + h - 1 ) , ( x + w - 1 , y + h - 1 ) , ( x + \frac{w}{2} , y + \frac{h}{2} ) , ( x , y + \frac{h}{2} ) , ( x + \frac{w}{2} , y ) .$$

In one sub-embodiment, the pre-defined positions (x′, y′) are outside of the corresponding area of the current encoding block, i.e., x′<x+or x′≥x+w, and y′<y or y′≥y+h. The pre-defined positions can be (x−1, y), (x, y−1), (x−1, y−1), (x+w, y), (x+w−1, y−1), (x+w, y−1),(x, y+h),(x−1, y+h−1),(x−1, y+h),(x+w, y+h−1),(x+w−1, y+h),(x+w, y+h).

In one embodiment, the models from the positions closer to (x,y) are added into the final merge candidate list first.

The previous coded picture, from which the inherited parameter model is obtained, is referred to as the collocated picture hereafter.

In one embodiment, the previous coded picture where the inherited parameter model is from, i.e., the collocated picture, is one of the pictures in the reference lists.

In one embodiment, the collocated picture is signaled in the picture/slice header. The reference list and the reference index are signaled in the picture/slice header. For example, the collocated picture is selected as L0[0]. For another example, the collocated picture is selected as L1[0].

In one embodiment, as shown in FIG. 12, the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy.

In one sub-embodiment, if the prediction mode of the current block is inter, Δx and Δy are set to the horizontal and vertical motion vector of the current block.

In another sub-embodiment, if the current block is inter bi-prediction, Δx and Δy are set to the horizontal and vertical motion vector in reference picture list 0.

In another sub-embodiment, if the current block is inter bi-prediction, Δx and Δy are set to the horizontal and vertical motion vector in reference picture list 1.

### 5.4. Inheriting Non-Adjacent Spatial Neighboring Models

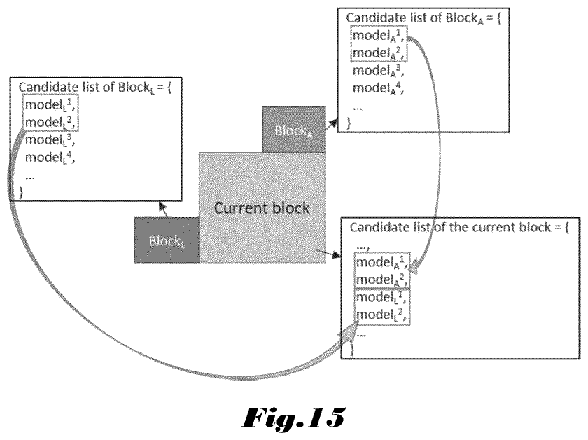

In one embodiment, the inherited model parameters can be from blocks that are non-adjacent spatial neighboring blocks. The models from blocks at pre-defined positions are added into the candidate list in a pre-defined order. FIG. 13 illustrates an example of inheriting non-adjacent spatial neighboring models.

In one sub-embodiment, the pre-defined positions and the pre-defined order are the same as those of non-adjacent spatial neighboring candidates for inter merge mode.

In one sub-embodiment, the pre-defined positions and the pre-defined order are as depicted in FIG. 13. The positions of the numbered squares are the pre-defined positions. The number inside each square indicates the pre-defined order. Positions in Pattern 1 are added into the list before positions in Pattern 2. The distance between each pre-defined positions are proportional to the width and height of the current block.

In one embodiment, there is a maximum number of inherited models from non-adjacent spatial neighbors that can be added into the candidate list, and the maximum number is smaller than the number of pre-defined positions.

5.5 Inheriting Model Parameters from History Table

In one embodiment, the inherited model parameters can be from a cross-component model history table. The history table stores CCM information of valid previous coded blocks. The valid previous coded block refers to any blocks containing valid CCM information. The cross-component models in the history table can be added into the candidate list according to a pre-defined order. In one embodiment, the adding order of historical candidate can be from the beginning of the table to the end of the table. In another embodiment, the adding order of historical candidate can be from the end of the table to the beginning of the table.

In one embodiment, one cross-component model history table can be maintained for storing the previous cross-component model (i.e., CCM information), and the cross-component model history table can be reset at the start of the current picture, current slice, current tile, every M CTU rows or every N CTUs, N and M can be any value greater than 0. In another embodiment, the cross-component model history table can be reset at the end of the current picture, current slice, current tile, current CTU row or current CTU.

In another embodiment, multiple history tables are used for storing different type of cross-component model. For example, the first history table is used for storing single model, and the second history table is used for storing multi-model. For another example, the first history table is used for storing gradient model, and the second history table is used for storing non-gradient model. For another example, the first history table is used for storing simple linear model (e.g., y=ax+b), and the second history table is used for storing complicated model (e.g., CCCM).

In one embodiment, when adding historical candidates from multiple history tables to the candidate list, the adding order can be from the beginning of to the end of a certain table, and then the next history table is added in the same order or in a reversed order.

5.6 Inheriting from Fusion Mode

Fusion mode refers to mode that fuses two predictions to generate the final prediction. In the chroma intra fusion mode, a chroma intra prediction that is not generated using a cross-component prediction (CCP) coding tool (e.g., CCLM, MMLM, CCCM) is fused with another chroma intra prediction generated using a cross-component prediction coding tool. For example, a non-CCLM coded intra prediction and a CCLM coded intra prediction are fused together to obtain the final intra prediction.

In one embodiment, when inheriting the cross-component model parameters from the block/position coded by chroma intra fusion mode, the model parameters for obtaining the CCP coded intra prediction are inherited and further refined.

In one embodiment, in addition to inheriting and refining the CCP model parameters, the fusion weight, the coding mode of non-CCP coded intra prediction are also inherited. That is, the chroma intra fusion mode is inherited.

### 5.7. Models Generated Based on Other Inherited Models

In another embodiment, a single cross-component model can be generated from a multiple cross-component model. For example, if a candidate is coded with multiple cross-component models (e.g., MMLM, or CCCM with multi-model), a single cross-component model can be generated by selecting the first or the second cross-component model in the multi cross-component models.

### (6) Constructing a Candidate List

In one embodiment, the candidate list is constructed by adding candidates in a pre-defined order until the maximum candidate number is reached. The candidates added can include all or some of the aforementioned candidates, but not limited to the aforementioned candidates. For example, the pre-defined order can be spatial adjacent candidates, temporal candidates, spatial non-adjacent candidates, historical candidates, and then default candidates. For example, the candidate list can include spatial neighboring candidates, temporal neighboring candidate, historical candidates, non-adjacent neighboring candidates, single model candidates generated based on other inherited models. For another example, the candidate list can include the same candidates as previous example, but the candidates are added into the list in a different order.

In another embodiment, if all the pre-defined neighboring and historical candidates are added but the maximum candidate number is not reached, some default candidates are added into the candidate list until the maximum candidate number is reached.

In one embodiment, the default candidates can be CCLM models. The scaling parameter α is from the set {0,⅛,−⅛,+ 2/8,− 2/8,+⅜,−⅜,+ 4/8,− 4/8, . . . , +N/8,−N/8}, where N is a positive integer. For example, the set can be {0,⅛,−⅛,+ 2/8,− 2/8,+⅜,−⅜,+ 4/8,− 4/8}. The offset parameter β can be

$$\frac{1}{1 ≪ bit\_depth}$$

or can be derived based on neighboring luma and chroma samples. For example, if the average value of neighboring luma and chroma samples are lumaAvg and chromaAvg, β=chromaAvg−α·lumaAvg. In one sub-embodiment, the inclusion order of the default candidates can depend on the absolute value and the sign of the scaling parameter α. For example, the default candidates are added into the list in the following order: α=0,⅛,−⅛,+ 2/8,− 2/8,+⅜,−⅜,+ 4/8,− 4/8, . . . , +N/8,−N/8. The average value of neighboring luma samples (i.e., lumaAvg) can be calculated by all selected luma samples, the luma DC mode value the current luma CB, or the average of the maximum and minimum luma samples

$$( e . g . , lumaAvg = ( Max ( {x}_{A}^{0} , {x}_{A}^{1} ) + Min ( {x}_{B}^{0} , {x}_{B}^{1} ) + 1 ) ≫ 1 , \\ or lumaAvg = ( Min ( {x}_{A}^{0} , {x}_{A}^{1} ) + Max ( {x}_{B}^{0} , {x}_{B}^{1} ) + 1 ) ≫ 1 ) .$$

Similarly, average value of neighboring chroma samples (i.e. chromaAvg) can be calculated by all selected chroma samples, the chroma DC mode value of the current chroma CB, or the average of the maximum and minimum chroma samples

$$( e . g . , chromaAvg = ( Max ( {y}_{A}^{0} , {y}_{A}^{1} ) + Min ( {y}_{B}^{0} , {y}_{B}^{1} ) + 1 ) ≫ 1 , \\ or chromaAvg = ( Min ( {y}_{A}^{0} , {y}_{A}^{1} ) + Max ( {y}_{B}^{0} , {y}_{B}^{1} ) + 1 ) ≫ 1 ) .$$

In one embodiment, the default candidates include but not limited to the candidates described below. The default candidates are two-parameter GLM models: α·G+β, where G is the luma sample gradients instead of down-sampled luma samples L. The 16 GLM filters described in the section entitled “Gradient Linear Model (GLM)” are applied. The final scaling parameter α is from the set {0,⅛,−⅛,+ 2/8,− 2/8,+⅜,−⅜,+ 4/8,− 4/8}. The offset parameter

$$β = \frac{1}{1 << bit\_depth}$$

or is derived based on neighboring luma and chroma samples.

In another embodiment, a default candidate can be derived based on an earlier candidate in the candidate list with a delta scaling parameter refinement. For example, the earlier candidate is a CCLM model. If the scaling parameter of an earlier candidate is α, the scaling parameter of a default candidate is (α+Δα). For example, Δα can be ⅛,−⅛,+ 2/8,− 2/8,+⅜,−⅜,+ 4/8,− 4/8, . . . , +N/8,−N/8, where N is a positive integer. For example, Δα can be ⅛,−⅛,+ 2/8,− 2/8,+⅜,−⅜,+ 4/8,− 4/8. The offset parameter β can be derived based on (α+Δα) and the average values of neighboring luma and chroma samples of the current block. In one sub-embodiment, the earlier candidate is the first CCLM candidate added into the list. In one sub-embodiment, the inclusion order of the default candidates can depend on the absolute value and the sign of the refinement Δα. For example, the default candidates are added into the list in the following order: Δα=0,⅛,−⅛,+ 2/8,− 2/8,+⅜,−⅜,+ 4/8,− 4/8, . . . , +N/8,−N/8.

In another embodiment, a default candidate can be a shortcut to indicate a cross-component mode (i.e., using the current neighboring luma/chroma reconstruction samples to derive cross-component models) rather than inheriting parameters from neighbors. For example, default candidate can be CCLM_LT, CCLM_L, CCLM_A, MMLM_LT, MMLM_L, MMLM_T, single model CCCM, multiple models CCCM or cross-component model with a specified GLM pattern.

In another embodiment, a default candidate can be a cross-component mode (i.e., using the current neighboring luma/chroma reconstruction samples to derive cross-component models) rather than inheriting parameters from neighbors, and also with a scaling parameter update (Δα). Then, the scaling parameter of a default candidate is (α+Δα). For example, default candidate can be CCLM_LT, CCLM_L, CCLM_T, MMLM_LT, MMLM_L, or MMLM_T. For another example, Δα can be ⅛,−⅛,+ 2/8,− 2/8,+⅜,−⅜,+ 4/8,− 4/8. And the offset parameter of a default candidate can be derived by (α+Δα) and the average value of neighboring luma and chroma samples of the current block. For still another example, the Δα can be different for each color components.

In another embodiment, a default candidate can be an earlier candidate with partial selected model parameters. For example, suppose an earlier candidate has m parameters, it can choose k out of m parameters from the earlier candidate to be a default candidate, where 0<k<m and m>1.

In another embodiment, a default candidate can be the first model of an earlier MMLM candidate (i.e., the model used when the sample value is less than or equal to the classification threshold). In still another embodiment, a default candidate can be the second model of an earlier MMLM candidate (i.e., the model used when the sample value is greater than or equal to the classification threshold). In still another embodiment, a default candidate can be the combination of two models of an earlier MMLM candidate. For example, if the models of an earlier MMLM candidate are

$$\{ {c}_{0}^{0} , {c}_{1}^{0} , … , {c}_{M - 1}^{0} \} and \{ {c}_{0}^{1} , {c}_{1}^{1} , … , {c}_{M - 1}^{1} \} .$$

The model parameters of an default candidate can be

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which can be predefined or implicitly derived according to neighboring template cost, and cₓ^{y} is the x-th parameter of the y-th model.

In another embodiment, default candidates can be derived from reconstructed samples from non-adjacent neighboring regions. Let the current block position be at (x, y) and the block size be w×h. If the reconstructed samples in the M×N region located at (x+dx, y+dy) are available, the default candidates can be derived using reconstructed luma and chroma samples in the region. For example, M×N can be 8×8. For another example, M×N can be 16×8. For another example, M×N can be 16×16. For another example, M×N can be w×h.

In another embodiment, let the current block position be at (x, y) and the block size be w×h, the default candidates can be derived using reconstructed samples in the M×N region located at (x_{mid}+dx, y_{mid}+dy), if the reconstructed samples in the region are available. (x_{mid}, y_{mid})=(x+w/2, y+h/2).

In another embodiment, default candidates derived from reconstructed samples from non-adjacent neighboring regions can be any type of cross-component model or some particular types of cross-component model. For example, the derived model can be CCLM, MMLM, CCCM, CCCM multi-models, or other cross-component models. For another example, the derived model is CCCM model. For another example, the derived model is CCLM model. For another example, the derive model is CCCM or CCCM multi-models.

In another embodiment, assume two value sets ax and ay are defined as:

$${α}_{x} = \{ {α}_{x 1} , {α}_{x 2} , {α}_{x 3} , … , {α}_{xn} \} , {α}_{xi} < {α}_{xj} if i < j$$

$${α}_{y} = \{ {α}_{y 1} , {α}_{y 2} , {α}_{y 3} , … , {α}_{yn} \} , {α}_{yi} < {α}_{yj} if i < j$$

All values in αₓ and α_{y} are positive numbers. (dx, dy) can be (αₓᵢ×w, −α_{yi}×h), (−αₓᵢ×w, α_{yi}×h), (−αₓᵢ×w, −α_{yi}×h), (αₓᵢ×w, 0), (−αₓᵢ×w, 0), (0, α_{yi}×h), (0, y_{mid}−α_{yi}×h).

In another embodiment, the current block position is at (x, y) and the block size is w×h. Let δx and δy be two fixed positive numbers (dx, dy) can be (αₓᵢ×δx, −α_{yi}×δy), (−αₓᵢ× δx, +α_{yi}× δy), (−αₓᵢ×δx, −α_{yi}×δy), (αₓᵢ×δx, 0), (−αₓᵢ×δx, 0), (0, α_{yi}×δy), (0,−α_{yi}×δy).

When constructing a candidate list, candidates are included into the list according to a pre-defined order. For example, the pre-defined order can be spatial adjacent candidates, temporal candidates, spatial non-adjacent candidates, historical candidates, and then default candidates. In one embodiment, if cross-component models are derived for non-LM coded blocks, the candidate models of non-LM coded blocks are included into the list after including candidate models of LM coded blocks. In another embodiment, if cross-component models are derived for non-LM coded blocks, the candidate models of non-LM coded blocks are included into the list before including default candidates. In still another embodiment, if cross-component models are derived for non-LM coded blocks, the candidate models of non-LM coded blocks have lower priority to be included into the list than candidate models from LM coded blocks.

### (7) Removing or Modifying Similar Neighboring Model Parameters (Candidate List Modification Process)

The candidates in the candidate list can be further modified by application of a candidate list modification process, such as a pruning process.

When inheriting cross-component model parameters from other blocks, it can further check the similarity between the inherited model and the existing models in the candidate list or those model candidates derived by the neighboring reconstruction samples of the current block (e.g., models derived by CCLM, MMLM, or CCCM using the neighboring reconstruction samples of the current block). If the parameters of a candidate model are similar to the parameters of the existing models, the model would not be included into the candidate list. In one embodiment, the pruning process is executed. It can compare the similarity of (α×lumaAvg+β) or a with the existing candidates to decide whether to include the model of a candidate or not. For example, if the (α×lumaAvg+β) or α of the candidate is the same as one of the existing candidates, the model of the candidate is not included. For another example, if the difference of (α×lumaAvg+β) or a between the candidate and one of existing candidates is less than a threshold, the model of the candidate is not included. Besides, the threshold can be adaptive based on coding information (e.g., the current block size or area). For another example, when comparing the similarity, if a model from a candidate and the existing model both use CCCM, the similarity can be compared by checking the value of (c₀C+c₁N+c₂S+c₃E+c₄W+c₅P+c₆B) to decide whether to include the model of a candidate or not. In another embodiment, if a candidate position point to a CU which is the same CU as that of the existing candidates, the model of that candidate is not included. In still another embodiment, if the model of a candidate is similar to one of existing candidate models, it can adjust the inherited model parameters to let the inherited model be different from the existing candidate models. For example, if the inherited scaling parameter is similar to the scaling parameter of one of existing candidate models, the inherited scaling parameter can add a predefined offset (e.g., 1>>S or −(1>>S), where S is the shift parameter) to let the inherited parameter is different from the existing candidate models.

In another embodiment, only partial model parameters are compared with that of the existing models in the candidate list. For example, a CCLM candidate has scaling and offset parameters, only the scale or only the offset parameters of the inherited model are compared with those of existing candidates to determine if they are the same/similar or not. If the scale or offset parameters of both models are the same or similar, the inherited model will not be included into the candidate list. For another example, a CCCM candidate has c₀ to c₆ parameters, only n parameters (n<7) of the inherited model are compared with those of existing candidates to determine if they are the same/similar or not. If all of the n parameters are the same or similar, the model will not be included into the candidate list.

In another embodiment, it can apply a candidate model to the neighboring reconstruction samples of the current block, and compare the difference with the existing candidate models. The difference between the prediction generated by applying a candidate model to the neighboring reconstruction samples of the current block and the prediction generated by applying the existing candidate model to the neighboring reconstruction samples of the current block is compared. If the difference value is less than or equal to a threshold, the model will not be included into the candidate list. For example, assume the applied result is

$${p}_{j}^{nei}$$

and the corresponding results of the existing models in the candidate list are

$${p}_{0}^{nei} to {p}_{i}^{nei} . If \vert {p}_{j}^{nei} - {p}_{0}^{nei} \vert < th , \\ \vert {p}_{j}^{nei} - {p}_{1}^{nei} \vert < th , … , or \vert {p}_{j}^{nei} - {p}_{i}^{nei} \vert < th ,$$

the model will not be included into the candidate list. For the selection of the neighboring reconstruction samples, it can choose the neighboring reconstruction sample with the maximal value, the neighboring reconstruction sample with the minimal value, the mean/median/mode of the neighboring reconstruction samples, the left-side neighboring reconstruction samples, the above-side neighboring reconstruction samples, or the above-left neighboring reconstruction samples.

In another embodiment, the number of candidates with the same type (e.g., MMLM, CCCM, or GLM) is limited when including the candidates into the list. For example, if the current list has k candidates with MMLM type, it is not allowed to further include candidates with MMLM type into the list. For another example, if the current list has k candidates with CCCM type, it is not allowed to further include candidates with CCCM type into the list. For another example, if the current list has k candidates with GLM type, it is not allowed to further include candidates with GLM type into the list.

In another embodiment, default candidates will not be compared with the existing models in the candidate list and will be included into the candidate list.

### (8) Reordering the Candidates in the List (Candidate List Modification Process)

The candidate list can be further modified by application of a candidate list modification process, such as a reordering process.

The reordering process is applied to reduce the syntax overhead when signalling the selected candidate index.

In one embodiment, the reordering rules can depend on the coding information of neighboring blocks or the model error. For example, if neighboring above or left blocks are coded by MMLM, the MMLM candidates in the list can be moved to the head of the current list. Similarly, if neighboring above or left blocks are coded by single model LM or CCCM, the single model LM or CCCM candidates in the list can be moved to the head of the current list. Similarly, if GLM is used by neighboring above or left blocks, the GLM related candidates in the list can be moved to the head of the current list.

In one embodiment, the reordering rule is based on the model error by applying the candidate model to the neighboring templates of the current block, and then compare the error with the reconstruction samples of the neighboring template. For example, as shown in FIG. 14, the size of above neighboring template of the current block is wₐ×hₐ, and the size of left neighboring template of the current block is w_{b}×h_{b}. Suppose K models are in the current candidate list, and αₖ and βₖ are the final scaling and offset parameters after inheriting the candidate k. The model error of candidate k computed based on the above neighboring template is:

$${e}_{a}^{k} = {\sum }_{i , j} \vert ( {α}_{k} \times {recL}_{a}^{′ ( i , j )} + {β}_{k} ) - {recC}_{a}^{( i , j )} \vert$$

$$where , {recL}_{a}^{′ ( i , j )} and {recC}_{a}^{( i , j )}$$

are the reconstruction samples of luma (e.g., after downsampling process or after applying GLM pattern) and reconstruction samples of chroma at position (i, j) in the above template, and 0≤i<wₐ and 0≤j<hₐ.

Similarly, the model error of candidate k by the left neighboring template is:

$${e}_{b}^{k} = {\sum }_{m , n} \vert ( {α}_{k} \times {recL}_{b}^{′ ( m , n )} + {β}_{k} ) - {recC}_{b}^{( m , n )} \vert$$

$$where {recL}_{b}^{′ ( m , n )} and {recC}_{b}^{( m , n )}$$

are the reconstruction samples of luma (e.g., after applying downsampling process or GLM pattern) and reconstruction samples of chroma at position (m, n) in the left template, and 0≤m<w_{b} and 0≤n<h_{b}.

Then the model error of candidate k is:

$${e}^{k} = {e}_{a}^{k} + {e}_{b}^{k}$$

After calculating the model error among all candidates, it can get a model error list E={e⁰, e¹, e², . . . , e^{k}, . . . , e^{K}}. Then, it can reorder the candidate index in the candidate list by sorting the model error list in ascending order. FIG. 14 illustrates an example of the neighboring templates for calculating model error.

In still another embodiment, if the candidate k uses CCCM prediction, the

$${e}_{a}^{k} and {e}_{b}^{k}$$

are defined as

$${e}_{a}^{k} = {\sum }_{i , j} \vert ( c {0}_{k} \times {recL}_{a}^{′ ( i , j )} + c {1}_{k} \times {recL}_{a}^{′ ( i , j - 1 )} + c {2}_{k} \times {recL}_{a}^{′ ( i , j + 1 )} + c {3}_{k} \times {recL}_{a}^{′ ( i - 1 , j )} + c {4}_{k} \times {recL}_{a}^{′ ( i + 1 , j )} + c {5}_{k} \times P + c {6}_{k} \times B ) - {recC}_{a}^{( i , j )} \vert$$

$${e}_{b}^{k} = {\sum }_{i , j} \vert ( c {0}_{k} \times {recL}_{b}^{′ ( i , j )} + c {1}_{k} \times {recL}_{b}^{′ ( i , j - 1 )} + c {2}_{k} \times {recL}_{b}^{′ ( i , j + 1 )} + c {3}_{k} \times {recL}_{b}^{′ ( i - 1 , j )} + c {4}_{k} \times {recL}_{b}^{′ ( i + 1 , j )} + c {5}_{k} \times P + c {6}_{k} \times B ) - {recC}_{b}^{( i , j )} \vert$$

where c0ₖ, c1ₖ, c2ₖ, c3ₖ, c4ₖ, c5ₖ, and c6ₖ are the final filtering coefficients after inheriting the candidate k. P and B are the nonlinear term and bias term.

In still another embodiment, if the above neighboring template is not available, then

$${e}^{k} = {e}_{b}^{k} .$$

Similarly, if the left neighboring template is not available, then

$${e}^{k} = {e}_{a}^{k} .$$

If both templates are not available, the candidate index reordering method using model error is not applied.

In still another embodiment, not all positions inside the above and left neighboring template are used in calculating model error. It can choose partial positions inside the above and left neighboring template to calculate model error. For example, it can define a first start position and a first subsampling interval depending on the width of the current block to partially select positions inside the above neighboring template. Similarly, it can define a second start position and a second subsampling interval depending on the height of the current block to partially select positions inside the left neighboring template. In one embodiment, hₐ or w_{b} can be a constant value (e.g., hₐ or w_{b} can be 1, 2, 3, 4, 5, or 6). For another embodiment, hₐ or w_{b} can be dependent on the block size. If the current block size is greater than or equal to a threshold, hₐ or w_{b} is equal to a first value. Otherwise, hₐ or w_{b} is equal to a second value.

In one embodiment, the model error is calculated by applying only partial candidate model to the neighboring templates of the current block. For example, if a candidate model is a multi-model mode, such as MMLM or CCCM multi-model, only the first or the second model is applied on the neighboring templates when computing the model error.

In another embodiment, the model error is calculated by applying only partial selected model parameters to the neighboring templates of the current block. Suppose a candidate model has m parameters, k out of m parameters can be chosen from the candidate model, where 0<k<m and m>1. When computing the model error, the unchosen parameters are set to 0 while the chosen parameters are kept the same. In another embodiment, when the model error is calculated only based on partial selected model parameters, an offset is added to the calculated model error to be the final model error. The calculated model error is the difference between the reconstruction samples of the neighboring template and the prediction computed based on partial model parameters. If the calculated model error is denoted by e, the final model error, which is used in reordering, is e+Δe. For example, the offset Ae can be a fixed offset, or the mean of neighboring templates.

In another embodiment, the model error is calculated by applying precision-reduced model parameters to the neighboring templates of the current block. The bit-depth of the parameters can be reduced before applying the model parameters on the neighboring templates to compute the model error. For example, a clipping operation can be used to reduce the bit depth of the integer part or the fractional part of model parameters. For another example, a rounding operation can be used to reduce the bit depth of the integer part or the fractional part of model parameters. For another example, a pruning operation can be used to reduce the bit depth. If a model parameter is smaller than a pruning threshold, this parameter will be set to zero.

In still another embodiment, the candidates of different types are reordered separately before the candidates are added into the final candidate list. For each type of the candidates, the candidates are added into a primary candidate list of a pre-defined size N₁. The candidates in the primary list are reordered. The candidates with the smallest N₂ costs are then added into the final candidate list, where N₂≤N₁. In another embodiment, the candidates are categorized into different types based on the source of the candidates, including but not limited to the spatial neighboring models, temporal neighboring models, non-adjacent spatial neighboring models, and the historical candidates. In another embodiment, the candidates are categorized into different types based on the cross-component model mode. For example, the types can be CCLM, MMLM, CCCM, and CCCM multi-model. For another example, the types can be GLM-non active or GLM active.

In still another embodiment, after the candidates are reordered based on the template cost (i.e., the model error), the redundancy of the candidate can be further checked. A candidate is redundant if the template cost difference between it and its predecessor in the list is less than or equal to a threshold. If a candidate is redundant, it can be removed from the list, or it can be move to the end of the list.

(9) Inheriting Candidates from the Candidates in the Candidate List of Neighbors

The candidates in the current candidate list can be from neighboring blocks. For example, the first k candidates in the candidate list of the neighboring blocks can be inherited. As shown in FIG. 15, the current block can inherit the first two candidates in the candidate list of the above neighboring block and the first two candidates in the candidate list of the left neighboring block. For an embodiment, after adding the neighboring spatial candidates and non-adjacent spatial candidates, if the current candidate list is not full, the candidates in the candidate list of neighboring blocks are included into the current candidate list. For another embodiment, when including the candidates in the candidate list of neighboring blocks, the candidates in the candidate list of left neighboring blocks are included before the candidates in the candidate list of above neighboring blocks. For still another embodiment, when including the candidates in the candidate list of neighboring blocks, the candidates in the candidate list of above neighboring blocks are included before the candidates in the candidate list of left neighboring blocks.

FIG. 15 illustrates an example of inherit candidates from the candidates in the candidate list of neighbors. The term “block” in this invention can refer to TU/TB, CU/CB, PU/PB, or CTU/CTB.

The term “LM” in this invention can be viewed as one kind of CCLM/MMLM modes or any other extension/variation of CCLM (e.g. the proposed CCLM extension/variation in this invention). One variation is MMLM which uses thresholds to decide different models for different samples in the current chroma component. Another variation is that for Cb (or Cr), deriving model parameters from multiple collocated luma blocks. The following shows more possible variations. The variations of CCLM here mean that some optional modes can be selected when the block indication refers to using one of cross-component modes (e.g., CCLM_LT, MMLM_LT, CCLM_L, CCLM_T, MMLM_L, MMLM_T, and/or an intra prediction mode, which is not one of traditional DC, planar, and angular modes) for the current block. The following shows an example of being convolutional cross-component mode (CCCM) as an optional mode. When this optional mode is applied to the current block, cross-component information with a model, including non-linear term, is used to generate the chroma prediction. The optional mode may follow the template selection of CCLM, so CCCM family includes CCCM_LT CCCM_L, and/or CCCM_T.

The proposed methods (for CCLM) in this invention can be used for any other cross-component modes.

Any combination of the proposed methods in this invention can be applied.

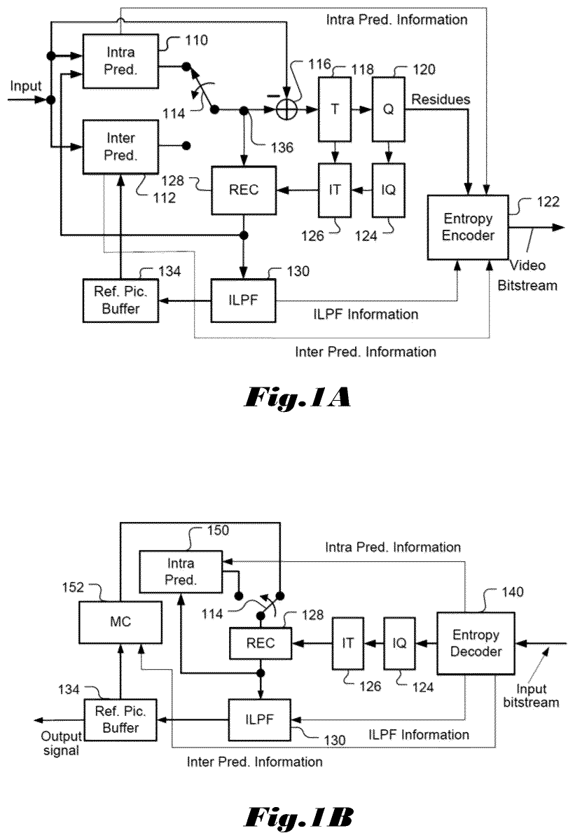

Any of the foregoing proposed using cross-component models related methods can be implemented in encoders and/or decoders. For example, any of the proposed methods can be implemented in an intra (e.g. Intra 150 in FIG. 1B)/inter coding module of a decoder, a motion compensation module (e.g. MC 152 in FIG. 1), a merge candidate derivation module of a decoder.

FIG. 16 illustrates a flowchart of a video decoding method according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block of a current image of a video is received, and wherein the current block is coded in a non-intra mode in step 1610. A candidate list corresponding to the current block is constructed, wherein the candidate list comprises cross-component models, and the cross-component models comprise at least one self-derived cross-component model or at least one candidate generated according to motion information of the current block in step 1620. One or more selected models from the candidate list are selected in step 1630. The current block based on the one or more selected models is reconstructed in step 1640.

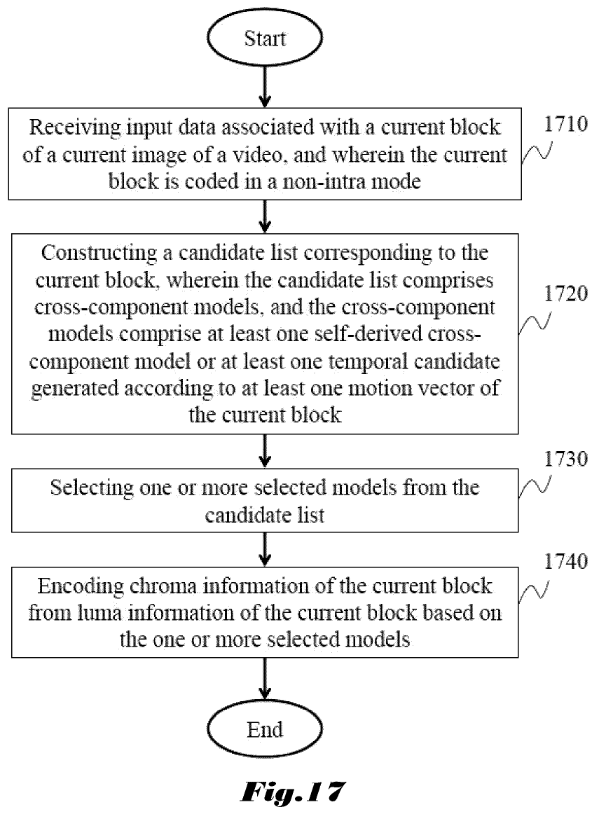

FIG. 17 illustrates a flowchart of a video encoding method according to an embodiment of the present invention. According to this method, input data associated with a current block of a current image of a video is received, and wherein the current block is coded in a non-intra mode in step 1710. A candidate list corresponding to the current block is constructed, wherein the candidate list comprises cross-component models, and the cross-component models comprise at least one self-derived cross-component model or at least one temporal candidate generated according to at least one motion information of the current block in step 1720. One or more selected models from the candidate list are selected in step 1730. The chroma information of the current block is encoded from luma information of the current block based on the one or more selected models in step 1740.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A video decoding method, comprising:
receiving input data associated with a current block of a current image of a video, and wherein the current block is coded in a non-intra mode;
constructing a candidate list corresponding to the current block, wherein the candidate list comprises cross-component models, and the cross-component models comprise at least one self-derived cross-component model or at least one candidate generated according to motion information of the current block;
selecting one or more selected models from the candidate list; and
reconstructing the current block based on the one or more selected models.

2. The video decoding method of claim 1, wherein the motion information of the current block is a motion vector or a block vector of the current block.

3. The video decoding method of claim 1, wherein the video decoding method further comprising:
generating chroma prediction of the current block from luma information of the current block based on the one or more selected models to reconstruct the current block.

4. The video decoding method of claim 1, wherein the cross-component models further comprise inherited cross-component models.

5. The video decoding method of claim 4, wherein the inherited cross-component models comprise at least one of spatial model, temporal model, history-based model, pairwise average model and default model.

6. The video decoding method of claim 1, wherein the at least one self-derived cross-component model is CCRM

7. The video decoding method of claim 1, wherein the self-derived cross-component model is derived through a weight derivation process, wherein the weight derivation process comprises calculating a relationship weight between a target chroma prediction and at least one of one or more source terms from luma component, one or more source terms from chroma components, and one or more bias terms.

8. The video decoding method of claim 1, wherein the method further comprises a candidate list modification process.

9. The video decoding method of claim 8, wherein the candidate list modification process comprises a reordering process, wherein the reordering process comprises a reordering rule for reordering the cross-component models in the candidate list.

10. The video decoding method of claim 9, wherein the reordering rule is based on model error calculated by computing difference between prediction generated by applying each of the cross-component models to neighboring templates of the current block, and reconstruction of the neighboring template.

11. The video decoding method of claim 10, wherein the difference is calculated using Sum of Absolute Difference (SAD).

12. The video decoding method of claim 10, the cross-component model with the smallest model error are selected to reconstruct the current block.

13. The video decoding method of claim 8, wherein the candidate list modification process comprises a pruning process, wherein the pruning process comprises determining whether to include a new cross-component model into the candidate list by calculating a similarity between the new cross-component model and the cross-component models in the candidate list or by calculating a similarity between the new cross-component model and another self-derived model.

14. The video decoding method of claim 13, wherein the pruning process calculates the similarity based on the difference between the model parameters of two models.

15. The video decoding method of claim 14, if the similarity is smaller than or equal to a threshold, the new cross-component model is not included in the candidate list.

16. A video encoding method, comprising:
receiving input data associated with a current block of a current image of a video, and wherein the current block is coded in a non-intra mode;
constructing a candidate list corresponding to the current block, wherein the candidate list comprises cross-component models, and the cross-component models comprise at least one self-derived cross-component model or at least one temporal candidate generated according to at least one motion vector of the current block;
selecting one or more selected models from the candidate list; and
encoding chroma information of the current block from luma information of the current block based on the one or more selected models.

17. A video decoding apparatus, comprising:
a processer, which is configured to:
receive input data associated with a current block of a current image of a video, and wherein the current block is coded in a non-intra mode;
construct a candidate list corresponding to the current block, wherein the candidate list comprises cross-component models, and the cross-component models comprise at least one self-derived cross-component model or at least one temporal candidate generated according to at least one motion vector of the current block;
select one or more selected models from the candidate list; and
reconstruct the current block based on the one or more selected models.
